(19) United States
(12) Patent Application Publication
(10) Pub. No.: US 2023/0301275 A1
(43) Pub. Date: Sep. 28, 2023

(54) ANIMAL COLLAR

(71) Applicant: Faith R. Douglas, Mount Holly, NC (US)

(72) Inventor: Faith R. Douglas, Mount Holly, NC (US)

(21) Appl. No.: 18/187,834

(22) Filed: Mar. 22, 2023

Related U.S. Application Data
(60) Provisional application No. 63/323,596, filed on Mar. 25, 2022.

(51) Int. Cl. A01K 27/00

(52) U.S. Cl. CPC A01K 27/006; A01K 27/002; A01K 27/001

(57) ABSTRACT

An animal collar defining a cavity to enhance visibility of information and identification tags. The collar includes a strap having an attachment point positioned thereon. At least one receiver is defined by the strap. The receiver includes a cavity configured to receive and retain information tag.

### TECHNICAL FIELD AND BACKGROUND OF THE INVENTION

The present invention relates to the field of collars for animals, and more specifically to a retention and display system for identification and information tags related to the animals.

### SUMMARY OF THE INVENTION

Animal collars are commonly used to provide attachment points for leashes and tethers. Another common use for animal collars is to provide a location for displaying identification and other information related to the animal. Such information is generally presented on engraved or printed tags. The tags are conventionally made of metal or other durable material. The tags are conventionally connected to the collar by a metal split ring. This type of connection does not fix the position of the tag relative to the collar. It also allows the tag to dangle below the animal's head and neck.

One problem with conventional animal collars is that the tags move relative to the collar, making them difficult to read.

Another problem with conventional animal collars is that the tags hang below the neck making them difficult to read.

Another problem with conventional animal collars is that tags dangle away from an animal's neck and thus can get dirty such that information engraved on the tag is obscured during general activity or in particular, during eating.

The disclosed technology addresses these and other problems by providing retainers for identification tags configured to maintain a visible position on the collar.

The disclosed technology provides an animal collar defining a cavity to enhance visibility of information and identification tags. The collar includes a strap having an attachment point positioned thereon. At least one receiver is defined by the strap. The receiver includes a cavity configured to receive and retain an information tag.

### BRIEF DESCRIPTION OF THE DRAWINGS

The invention may be best understood by reference to the following description in conjunction with the accompanying drawing figures in which:

FIG. 1 is a side view of an animal collar according to the presently disclosed technology;

FIG. 2 is an overhead plan view of a portion of the animal collar shown in FIG. 1;

FIG. 3 is a side cross-sectional view of the portion of the animal collar shown in FIG. 2 taken along line 3-3;

FIG. 4 is a side view of the animal collar shown in FIG. 1 showing internal structure via hidden lines;

FIG. 5 is a side view of an alternative embodiment of the animal collar shown in FIG. 1 including counterbalancing weights;

FIG. 6 is an overhead partial view of an alternative embodiment wherein the animal collar is incorporated into a harness.

### DESCRIPTION OF THE PREFERRED EMBODIMENT AND BEST MODE

Referring now specifically to the drawings, an animal collar 10 is shown. The animal collar 10 is configured for physical control and identification of various animals such as pets, working animals, and livestock. The animal collar 10 is configured to retain information tags 16 such as identification tags, registration tags, and/or medical tags such as rabies certifications. The animal collar 10 is configured to retain information tags such that they are generally exposed and easy to read.

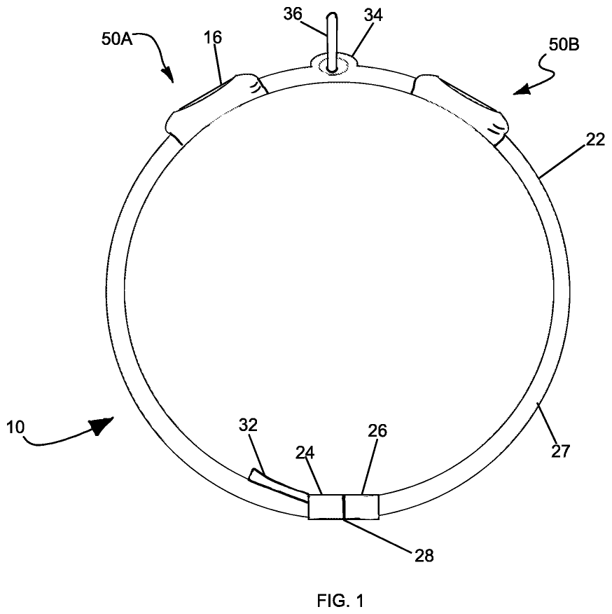

Referring now to FIG. 1, the animal collar 10 includes a strap 22 that extends between a first end 24 and a second end 26 and has two opposing sides 27. The first end 24 and the second end 26 include connecting components such as conventionally known. As shown, the connecting components comprise a quick connecting buckle 28. The quick connecting buckle 28 comprises an adjustable section for adjusting the length of the strap 22 resulting in an end tag 32. The strap 22 also includes an attachment point 34 configured to receive a D-ring 36. The D-ring 36 is configured for use with a conventional connection to a leash or tie-down.

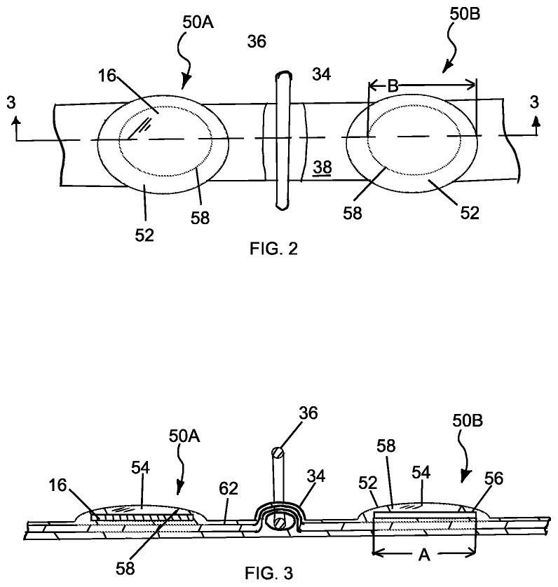

Referring now to FIGS. 1-3, as shown in the illustrated embodiment, a pair of receivers 50 are provided on either side of the attachment 34. Each receiver 50 is configured to receive and retain a tag 16. It should be appreciated that in some embodiments a single receiver 50 is provided and in other embodiments multiple receivers 50 are provided. A receiver 50 identified as 50A is shown with a tag 16 positioned therein. A receiver 50 identified as 50B is shown empty.

Each receiver 50 includes a perimeter wall 52 that defines a cavity 54. The perimeter wall 52 extends away from a surface 38 defined by the strap 22. In some embodiments, the perimeter wall 52 is defined within the body of the strap 22 such that the wall 52 does not extend beyond the surface 38. The wall 52 has a circumferential slot 56 defined therein and the wall 52 defines an opening 58. The circumferential slot 56 has a predetermined diameter A that is greater than a predetermined diameter B of the opening 58. It should be appreciated that the diameters A and B are taken along the same radial axis. According to the illustrated embodiment, the tag 16 has a diameter between A and B can be retained within the circumferential slot 56. In the illustrated embodiment, the wall 58 is comprised of the material that is flexible such that the tag 16 can be pressed through the opening 58 and retained within the circumferential slot 56. In alternative embodiments the tag 16 and the wall 58 can have corresponding tabs and slots such that the tag 16 is keyed to the wall 58 and can be retained after being inserted and moved radially such that tabs on tag 16 retain the corresponding tabs to wall 58. In yet another embodiment, the tag can have a diameter greater than A and B with no tag such that the wall 58 stretches to retain the tag.

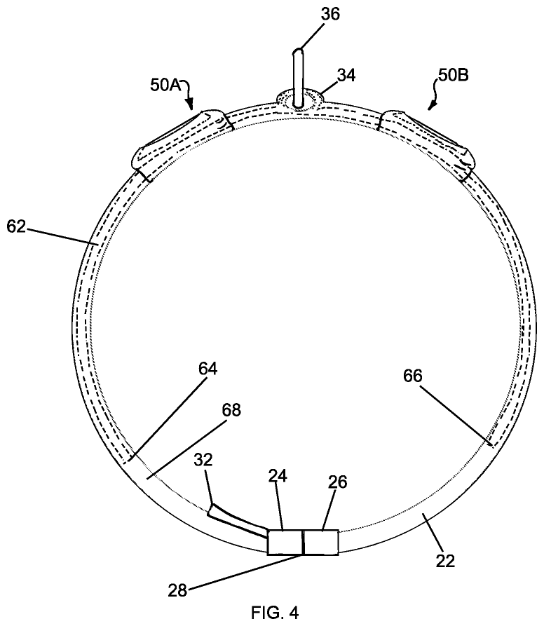

Referring now to FIG. 4, The strap 22 has a reinforcement layer 62 that extends at least partially along the length of the strap 22 between a first end 64 and a second end 66. The reinforcement layer 62 is surrounded by a primary component 68. According to the illustrated embodiment, the primary component 68 is a durable and stretchable silicon material or other flexible material suitable for animal collars such as leather. By way of example and not limitation, the material of the reinforcing layer 62 is one of the following: metal, plastic, paper, woven textile, nonwoven textile, other durable material and a combination thereof. It should be appreciated that in other embodiments, the animal collar 10 does not include a reinforcement layer 62.

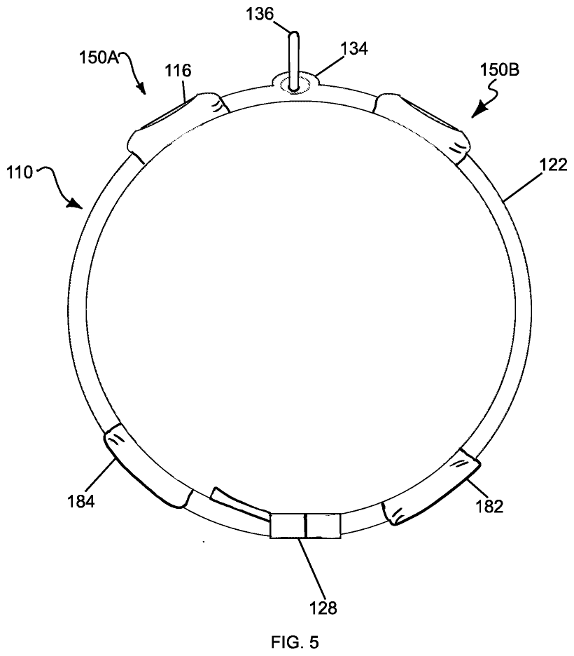

Referring now to FIG. 5, an alternative embodiment is shown with elements referenced by numbers in the 100 series. Elements with reference number substantially similar to reference numbers used above can be understood by a description of those elements. According to the alternative embodiment, a collar 110 that includes a strap 122. A first receiver 150A in which an identification tag 116 is positioned therein and a second receiver 150 B are positioned on the strap 122. Between the receivers 150A and 150B is an attachment point 134 and a D-ring 136 engaged with the attachment 134. As shown in FIG. 5, the strap 122 includes a buckle 128 that is generally opposite the attachment point 134. It should be appreciated that the buckle 128 can be positioned at generally any location along the strap 122.

A pair of counterbalancing weights 182 and 184 are positioned on the strap 122. As shown, the counterbalancing weights 182 and 184 are each positioned generally opposite a corresponding receiver 150A or 150B. The counterbalancing weights 182 are configured to shift the center of gravity of the collar 110 such that the receivers 150A and 150B are positioned substantially on top of or above the neck of the animal when the collar is in place. In this manner, the tag 116 is more easily visible. Each counterbalancing weight 182 and 184 can be repositioned individually along the strap 122 as necessary to compensate for changes such as, but not limited to, changes in collar diameter.

The counterweights 182 and 184 can be formed of the same material as the strap 122. Alternatively, the counterweights 182 and 184 can be of a high-density material such as a metal. The counterweights 182 and 184 retained in a position by resistance fit on the strap 122, by rivets, by receivers that are analogous to the receivers 150A 150 B, or the like.

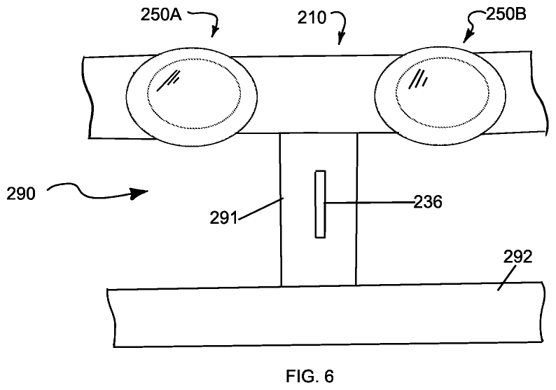

According to an alternative embodiment shown in FIG. 6, there is provided a collar 210 is incorporated into a harness 290. The collar 210 is substantially similar to the collar 10 described above and elements that have similar reference numbers in the 200 series can be understood from the description of elements having similar reference numbers in the 0 series as described above. The harness 290 includes the collar 210 which is connected to a body strap 292 by a cross strap 291. A D-ring 236 is attached to the cross strap 291. It should be appreciated that in some embodiments, the D-ring 236 is attached to a chest band that extends from one side of the collar 210 to the other side of the collar 210 such that when the harness is worn by the animal, a leash can be connected to the front portion of the animal providing additional control.

A pair of receivers 250A and 250B are defined by the collar 210. The pair of receivers 250A and 250B are positioned such that they located generally above the shoulders of the animal wearing the harness 290.

An animal collar has been disclosed above. Various details of the invention may be changed without departing from its scope. Furthermore, the foregoing description of the preferred embodiments of the invention and best mode for practicing the invention are provided for the purpose of illustration only and not for the purpose of limitation.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. An animal collar configured to enhance visibility of information and identification tags, the collar comprising:
a strap;
an attachment point;
at least one receiver is defined by the strap; and
wherein the receiver includes a cavity that is configured to receive and retain an information tag.

13. The animal collar according to claim 12, wherein the cavity is generally parallel to a wide surface of the strap.

14. The animal collar according to claim 13, wherein the cavity is defined by the body of the strap.

15. The animal collar according to claim 13, wherein the cavity is defined by walls extending away from the strap.

16. The animal collar according to claim 15, wherein the receiver is wider than the strap.

17. The animal collar according to claim 14, wherein the strap is comprised of a flexible material.

18. The animal collar according to claim 14, wherein the circumferential slot is defined within the strap around the cavity and the slot is configured to receive the information tag.

19. The animal collar according to claim 15, wherein a circumferential slot is defined in the walls that extend away from the strap and the slot is configured to receive the information tag.

20. The animal collar according to claim 12, wherein at least one weight is positioned on the strap generally opposite the receiver.

21. The animal collar according to claim 12, wherein the collar includes multiple receivers.

22. The animal collar according the claim 12, wherein the collar is incorporated into a harness.
